(19) United States
(12) Patent Application Publication
(10) Pub. No.: US 2023/0108347 A1
(43) Pub. Date: Apr. 6, 2023

(54) METHOD FOR MANUFACTURING SECONDARY BATTERY, OR SECONDARY BATTERY

(71) Applicant: MTEK-SMART CORPORATION, Yokohama-Shi, Kanagawa (JP)

(72) Inventor: Masafumi MATSUNAGA, Yokohama-Shi (JP)

(73) Assignee: MTEK-SMART CORPORATION, Yokohama-Shi, Kanagawa (JP)

(21) Appl. No.: 17/909,684

(22) PCT Filed: Mar. 1, 2021
(86) PCT No.: PCT/JP2021/007789

§ 371 Date: Sep. 6, 2022

(30) Foreign Application Priority Data
Mar. 7, 2020 (JP) 2020-039420

(51) Int. Cl. H01M 4/04

(52) U.S. Cl. CPC H01M 4/0419

(57) ABSTRACT

A method for manufacturing a secondary battery by coating an electrode slurry on an object for a secondary battery. A step of pressurizing and transferring the slurry to the next step; a step of transferring pressurized carbon dioxide gas or liquefied carbon dioxide or supercritical fluid of carbon dioxide gas to the next step; a step of merging and mixing the slurry and the carbon dioxide gas or liquefied carbon dioxide or supercritical fluid of carbon dioxide gas; and a step of coating the mixed mixture or layered coating a plurality of layers thereof on the object with a coating device. As a result, the total length of a drying device is extremely short, and the desired thick film of the positive electrode can be easily formed. In addition, a solid electrolyte layer can be formed in a short time.

### TECHNICAL FIELD

The present invention relates to a method for manufacturing a secondary battery, and in detail, particles or short fibers or the like of an active material or a conductive assistant, etc. are mixed with a solvent, and if necessary, a thickener and a binder to form a slurry, an electrode layer is formed on current collectors of positive electrode and negative electrode, a separator is used as an intermediate layer, and an electrolyte liquid is sealed to manufacture, for example, a lithium-ion secondary battery. In addition, in an all-solid-state battery, since solid electrolytes are used, a separator is not normally used, but a heat-resistant film such as polyimide or the like can be provided with many openings, and the openings can be applied or filled with solid electrolyte particles or the like to be used as an electrolyte layer.

The present invention also includes a method for manufacturing an all-solid-state battery composed of a laminate in which a solid electrolyte layer is formed of solid electrolyte particles or the like, and a positive electrode layer, a solid electrolyte layer, and a negative electrode layer are laminated, and a next-generation secondary battery such as the manufactured all-solid-state battery. Although the method for manufacturing an all-solid-state battery is mainly described in the detailed description, the present manufacturing method is suitable for all secondary batteries, and is also suitable for a manufacturing method including the formation of a positive electrode and a negative electrode of a secondary battery such as a lithium-ion battery and a lithium-ion polymer battery. In addition, it is suitable for all storage batteries, and needless to say, it can also be applied to all-solid-state air batteries or the like, which are considered to be promising next-generation batteries.

The present invention is a method for manufacturing a secondary battery or a secondary battery, and more particularly, at least one of a current collector for positive electrode, a positive electrode layer, a solid electrolyte layer, a negative electrode layer, a current collector for negative electrode, a separator for electrolyte is used as an object, a desired material is selected from various materials such as positive electrode active material particles, solid electrolyte particles or/and short fibers, negative electrode active material particles or/and short fibers, conductive assistant particles or/and short fibers, or separator ceramic particles, a solvent is added, and if necessary, a thickener and a binder can be added and mixed to form a slurry.

In addition, in the present invention, the respective fine particles or short fibers can be independently made into a slurry or a dispersion (solvent dispersion), or all the particles or the like can be mixed to form a slurry.

In the following description of the present invention, dispersion is also expressed as slurry.

### BACKGROUND ART

With the increase in mobiles and electric vehicles, high power and quick charging of secondary batteries including lithium batteries are required, but large electric vehicles or the like require one hour or more. The researches to improve the performance by thickening the positive electrode layer are progressing due to the length of the charging time, risk of safety, miniaturization and higher performance of the battery system. However, normal methylpyrrolidone (hereinafter referred to as NMP) is often used as a solvent for polyvinylidene fluoride (hereinafter referred to as PVDF), which is the binder for the positive electrode layer of lithium-ion batteries, and has a high boiling point, hence a high-temperature and long drying oven is required. On the other hand, the development of next-generation secondary batteries to change the electrolyte from liquid to solid is progressing. A representative all-solid-state battery has a solid electrolyte layer, so there is an advantage such as not requiring a cooling device and not igniting. For the above reasons, the goal of the industry is to reduce the total space of batteries and manufacture batteries of the same size but with several times more power. In addition, in order to improve discharge characteristics at a high rate, a method has been proposed in which the density of the active material is changed with increasing distance from both the positive and negative current collectors in lithium-ion secondary batteries. In addition, for all-solid-state batteries, the goal is to improve performance even in high-speed charging and discharging, such as by considering gradient coating in which the ratio of the active material of both electrode layers to the electrolyte is changed from the collector to the electrolyte layer.

In Patent Literature 1, a method for manufacturing a layer structure of a solid electrolyte layer, a positive electrode active material layer, and a negative electrode active material layer of an all-solid-state battery is proposed, and a technique for which a slurry containing materials constituting the layer structure is prepared to form a green sheet, and the green sheet and a sheet having unevennesses that disappear by heating are integrally formed, and unevennesses are formed on the surface of the green sheet, the integrally formed green sheet and the sheet are heated to eliminate the sheet member, and an electrode is formed while forming unevennesses on the substrate by calcinating a green sheet or the like.

In Patent Literature 2, a polyvinyl acetal resin that can be degreased at a low temperature in a short time has been proposed, which is used for an electrode slurry composed of active material particles, a solvent and a binder, and is used for an electrolyte slurry composed of electrolyte particles, a solvent and a binder, and these slurries are used for forming an electrode layer and an electrolyte layer of an all-solid-state battery and laminating them. More specifically, a solid electrolyte slurry, a negative electrode slurry or a positive electrode slurry is applied to support layer of the PET film that has been demolded, dried at 80° C. for 30 minutes, then the PET film is peeled off, and the electrolyte layer is sandwiched between the negative electrode and positive electrode active material layers and heated and pressurized at 80° C. and 10 KN to obtain a laminate, and a conductive paste containing acrylic resin is applied on a stainless steel plate to prepare a current collector, and the binder is degreased by calcinating at 400° C. or lower in a nitrogen gas atmosphere.

In the method of Literature 1, it is ideal to coat the active material slurry or the electrolyte slurry on the sheet such as polyvinyl alcohol formed with unevennesses to increase the contact area of the active material layer or the electrolyte layer, but there is a problem that it is necessary to eliminate the resin component at a high temperature for a long time, for example, it takes 50 hours at 700° C.

On the other hand, in Literature 2, it takes 30 minutes to volatilize the solvent component of the slurry at 80° C., so there is a problem that the line becomes too long in order to replace the current line speed of, for example, 60 m/min for lithium-ion batteries, or the line speed has to be slow down.

### CITATION LIST

### Patent Literature

Patent Literature 1: WO2012/053359
Patent Literature 2: JP2014-212022

### SUMMARY OF INVENTION

### Technical Problem

In addition, in either method, if the binder of the slurry is eliminated or reduced to a very small amount, particles will precipitate at places where the slurry tends to stay in a general slurry circulation device, and application and adhering to the object becomes difficult with a die head used for forming electrodes of lithium batteries. In addition, in all-solid-state batteries, for each electrode, it is necessary to uniformly mix the active material particles and the electrolyte particles or the conductive assistant in a desired ratio to form an electrode, but especially when the binder content is 5% or less, or even 3% or less, and the viscosity is low, even if it is uniformly dispersed and mixed with a commercially available dispersion device, it will change instantaneously or over time, and only electrodes with unstable performance can be formed.

Since the binder is an insulator, it is preferably 3% or less, more preferably 2% or less of the total solid content if the binding force of the binder is strong. It is better in terms of workability and quality improvement to make it difficult to settle during handling with a total solid content of the slurry undiluted solution of 50% or more and a high viscosity, for example, 3000 mPa·s or more, further such as 8000 mPa·s or more, and further a high solid content of 80% or more and a high viscosity.

In addition, polyvinylidene fluoride which is also known as vinylidene fluoride (hereinafter collectively referred to as PVDF) is used as a binder for a lithium-ion secondary battery due to its solvent resistance and heat resistance or the like, but only high boiling point normal methylpyrrolidone (NMP) and highly toxic DMF or the like can dissolve PVDF. In the case of NMP, there was a big problem that evaporation of the solvent requires an excessively high drying temperature and drying time further than the solvent of the patent literature example introduced. Even in the current positive electrode forming device for secondary batteries with a relatively thin electrode thickness, the coating zone and the drying device have become huge. For example, a thick film of 0.1 to 1 mm, and in the case of an all-solid-state battery, even more, for example, a thick film of 2 mm is desired by one-time coating and drying, but the thicker the film thickness, the more sagging phenomenon such as the coating film flowing with NMP occurs on the current collector or the like on the object, in addition, it is almost impossible to form a desired positive electrode layer due to the occurrence of cracks or the like.

A major problem in the positive electrode formation of the patent literatures and conventional lithium-ion secondary batteries in particular, is the length of the drying time and the size of the oven.

In addition, in the conventional lithium-ion batteries, PVDF is often used as the binder in terms of heat resistance and chemical resistance or the like, and since its parent solvent is NMP with a high boiling point, a high-temperature and long drying oven is required.

On the other hand, it has been desired to increase the thickness of the positive electrode layer on the current collector, particularly in lithium-ion batteries and all-solid-state batteries or the like, in order to improve battery performance.

Generally speaking, the greater the amount of active material and the thicker the active material, the easier it is to store electricity, so the tendency is strong.

The present invention is to improve productivity by drying in a short time, for example, to improve battery performance by corresponding to thickening of the positive electrode layer.

### Solution to Problem

The content of the present invention to solve the above problems is clarified as follows.

1) A high boiling point solvent such as NMP is azeotroped by mixing or dissolving with a low boiling point solvent or an equivalently effective diluent (hereinafter referred to as a low boiling point solvent).

2) A slurry with a high solid content and a high viscosity can be made into low viscosity with a low boiling point solvent and coated.

3) The coated high boiling point solvent such as NMP should be evaporated as much as possible during coating or in a short time after that, and the amount of residual solvent should be minimized, and residual solvent should be useful for the flow of binder in the drying of the post-process and the binding of the desired parts afterwards.

4) The low boiling point solvent used is less dangerous than a general low boiling point solvent (MEK, acetone, etc.), and the total amount of carbon dioxide gas emissions from energy consumption for afterburner treatment of solvent vapor exhaust and recovery of solvent vapor can be reduced compared with conventional methods or the like.

The present inventor uses a supercritical fluid (hereinafter referred to as SCF: Super Critical Fluid) as an alternative to the low boiling point solvent. Or carbon dioxide gas is used as its predecessor. Furthermore, in order to reduce the total emission of carbon dioxide gas, and also from the aspect of cost, a method that aims to actively collect carbon dioxide gas or liquefied carbon dioxide, which is a by-product from thermal power plants, chemical plants, etc., and is easy to procure. As for the coating according to the present invention, by forming a mixture of the slurry and the carbon dioxide gas or making it into SCF (supercritical fluid), improving and applying a hot airless or warm airless spray system, coating such as spraying can be performed. In the present invention, a warm airless is defined as room temperature to less than 50° C., and hot airless is defined as 50° C. to less than 95° C.

In the coating method of the present invention, SCF can be handled, when a slurry or the like with a higher solid content (less solvent component such as NMP) and a high viscosity that does not easily precipitate is merged with carbon dioxide gas or a fluid obtained by making carbon dioxide gas into SCF, and the coating is performed by making the fluid into SCF, the liquid pressure and liquid temperature are not particularly limited, but there is no problem as long as the device can maintain the liquid pressure above the supercritical point of 7.38 MPa, for example, about 8 MPa or above, and the liquid temperature above the supercritical point of 31.1° C. or above, for example, 35° C. or above. For coating, airless spraying with a hot airless spray system that heats the fluid using a balanced feed type air-driven dual piston pump or the like with less pulsation with a liquid pressure of, for example, about 8 to 10 MPa (not below the supercritical point pressure) is preferable. In the balance feed method, since the liquid pressure is lowered and the balance is lost due to the amount of flow ejected by spraying or the like, that amount, for example, the amount of ejection or discharge can be instantaneously and automatically sucked by a pump to maintain the balance. Therefore, it is extremely effective. Accordingly, the ratio of the slurry to the carbon dioxide gas to be sucked by the pump can be determined and set in advance so that the operation can be automatically performed. The slurry and the carbon dioxide gas or carbon dioxide gas SCF (carbon dioxide gas supercritical fluid) can be merged in advance, introduced to the upstream of the pump from one flow path, and sucked by the pump. The pressure of the fluid introduced is lower than that of the SCF circulation circuit, more preferably a little lower, for example higher than the pressure drop during spraying, if the pressure is set below the circulating pressure, the set pressure can always be reached by the pump, and a whole system including a stable circulating circuit with well-balanced liquid pressure can be constructed as described above. For example, an electric pump or the like including an electric gear pump is not denied, and in the present invention, although complicated, the suction amount of carbon dioxide gas and slurry can also be automatically adjusted by utilizing a flow rate sensor, a pressure sensor, a density sensor or the like arranged in the SCF circuit. In terms of the temperature of the fluid, in order to form the SCF, the liquid temperature in the circulation circuit can be set to about 33 to 60° C. with a commercially available pressure-resistant explosion-proof heater and maintained by circulating the fluid or the like. It is possible to construct a type of system or the like capable of atomization such as a slot nozzle (die) coating system that utilizes the liquid pressure circuit, a slit nozzle coating system that makes the slurry or the like into particles and ejects them from a long and narrow slit groove, a dispenser coating system or an inkjet system that makes droplets into finer particle groups for coating. The particle production can be achieved by applying a particle generation method such as a two-fluid spray method that is airless or uses compressed gas. Regarding the fine particle generation method, it can be retrieved in many patent literatures or the like invented by the present inventors. In addition, the present coating method can exhibit characteristics not only for secondary batteries but also for a wide range of applications. Furthermore, in the present invention, spray particles or particle group obtained by spraying SCF can be transferred with carbon dioxide gas vaporized by spraying with SCF or another compressed gas, jetted as necessary, and coated to the object. It also includes a method in which the fine particle group is transferred at a high speed and applied to the object in a jetted fine pattern from an ejection port. The fine pattern may have a diameter of 10 mm or less, further 5 mm or less, further 2 mm or less, and may be micron units if necessary, and may be singular or plural. There may be, for example, 1 or 100 or more or fewer ejection ports. The ejection port may be of any shape, not only circular but also elliptical, quadranglar, for example, elongated rectangular. It is especially effective when applying only the required amount to the required area. As many ejection ports as there are, a stripe-like coating can be performed especially in the moving direction of the object. Accordingly, it is effective for forming a plurality of uneven line electrodes perpendicular to the moving direction of the secondary battery object, and also for applying alternating stripes of a plurality of types of materials for all-solid-state batteries.

Furthermore, it would be even better if a circuit could be created in which it is circulated at a high speed in a closed circuit that could maintain a supercritical state so that solid particles of the slurry or the like would not precipitate, and the liquid pressure and temperature as the conditions of the above SCF could be maintained. In addition, in the present invention, since it can be coated by spraying and electrostatically charging spray particles or fibers, in particular, when the average particle size of the fine particles is several nanometers to submicrons, and if necessary several micrometers, dispersion coating can be performed to adhere a very small amount to the entire object or the required area. In addition, a pulsed spray with impact is particularly effective for filling micrometer-sized or dozen micrometer-sized voids and adhering them at a high density. Regardless of the size of the fine particles, it is particularly effective to make a jet flow, and the pulsed jet flow is effective because it can be finely filled regardless of whether it is charged or not. In the present invention, a method corresponding to the object moving with wide and high-speed line speed by applying a melt blown spray gun method to the present invention can be adopted. In addition, as an application of the present invention, it can be applied to a method of producing particles or fibers from a solution or slurry containing a solvent for other uses, for example for chemical industrial products including pharmaceuticals, agricultural chemicals and fertilizers.

In the present invention, the air-assist method is used as an improved version of the airless spray and slot nozzle, but the air-assist coating method refers to a method for giving directionality to particles and liquid films, and adhering or coating them to the object by the force of a compressed gas (air assist) such as compressed air, argon or nitrogen gas that are inactive gases, if necessary, dry compressed air.

In addition, in the present invention, the above-mentioned method of coating by forming particles is generically referred to as spray.

The present invention has been made to solve the above-mentioned problems, and an object of the present invention is to manufacture high-performance and high-quality secondary batteries and next-generation secondary batteries, especially all-solid-state batteries and all-solid-state air batteries or the like at high speed, space saving, energy saving, and low cost.

Consequently, it is possible to correspond to the above detailed contents.

In the present invention, the low boiling point solvent added to the slurry can solve the above problems.

Therefore, the carbon dioxide gas, liquefied carbon dioxide, and supercritical fluid of carbon dioxide gas (hereinafter referred to as carbon dioxide gas SCF) are used as the low boiling point solvent which merges with the slurry upstream of the automatic coating device that coats the object.

The merged fluid can be finely mixed, and if necessary, a supercritical fluid (carbon dioxide gas SCF) of the slurry and the carbon dioxide gas can be obtained by adjusting the conditions. By forming SCF, for example, even the slurry with high solid content (50% or more) and high viscosity (8000 mPa·s or more) can be made into an ultra-low viscosity fluid of 100 mPa·s or less, or 50 mPa·s or less if desired, so it is suitable for airless spray. In addition, the low-viscosity SCF does not cause the fishtail phenomenon (a spray pattern looks like a fish tail, and both sides of the pattern cannot be atomized, resulting in large droplets that are not suitable for coating), which is a drawback of the airless spray. The spray pattern in which the slurry is made into SCF is a bell-shaped pattern that is suitable for composite coating of an isosceles triangular liquid airless spray pattern having both sharp ends and a pattern in which the gas is jetted by an airless spray nozzle. Accordingly, spray coating can be performed while the spray nozzle and the object are moved relative to each other. In the present invention, the coating can be performed by traversing the spray nozzle perpendicularly to an R to R substrate that is moved by a long unwinding and winding device. Generally speaking, the airless spray method has a coating flow rate ten times or more greater than that of the two-fluid spray method, so the production speed can be increased. Furthermore, the production volume can be increased by making the spray heads a parallel circuit to increasing the number of spray heads. In addition, when SCF, which consists of a low-viscosity slurry of distorted and hard solid particles, is sprayed with an airless spray nozzle at a high pressure, the cut edge part of the nozzle tip will be worn even if it is made of cemented carbide or ceramics, so that the fluid ejected from two round holes, or two tubes made of stainless steel or nickel or the like can be brought into close to collide with each other at a short distance of 0.2 to 1 mm for example, to form a spray pattern. Ceramics may be used for the tubes and holes. A hole diameter of 0.1 to 0.5 mm is preferable because it is related to the flow rate, and a collision angle of 15 to 90 degrees is suitable used for this application as a pattern.

Applying a pressure of 3.5 MPa to water and passing it through one hole with a diameter of 0.2 mm gives a flow rate of about 114 ml per minute, so the spray flow rate from two holes is 228 ml, which is in the low flow rate range for the airless method.

According to the present invention, there is provided a method for manufacturing a secondary battery by coating an electrode slurry on an object for a secondary battery, the method including a pressurizing step of pressurizing and transferring the slurry to post step, a transferring step of transferring pressurized carbon dioxide gas or liquefied carbon dioxide or supercritical fluid of carbon dioxide gas to the post step, a mixing step of merging and mixing the slurry and the carbon dioxide gas or liquefied carbon dioxide or supercritical fluid of carbon dioxide gas to obtain a mixture, and a coating step of coating the mixture on the object or layered coating thereof in form of a plurality of layers with a coating device.

According to the present invention, there is provided the method for manufacturing the secondary battery in which the mixing step is a step of making a supercritical fluid.

According to the present invention, there is provided the method for manufacturing the secondary battery in which merged fluid is mixed by an in-line mixer installed between before and after the merging.

According to the present invention, there is provided the method for manufacturing the secondary battery in which at least one fluid of the slurry and the carbon dioxide gas is transferred to the post step via an automatic opening/closing valve.

According to the present invention, there is provided the method for manufacturing the secondary battery in which liquid pressure and temperature of the merged fluid including the slurry and the carbon dioxide gas are set to supercritical point or more, the merged fluid is circulated by a circulation device for supercritical fluid to form the supercritical fluid, and the supercritical fluid is coated to the object.

According to the present invention, there is provided the method for manufacturing the secondary battery in which the secondary battery is an all-solid-state battery.

According to the present invention, there is provided the method for manufacturing the secondary battery in which the electrode slurry is a solid electrolyte slurry.

According to the present invention, there is provided the method for manufacturing the secondary battery in which at least one fluid of the slurry and the pressurized carbon dioxide gas or liquefied carbon dioxide is circulated at a temperature and pressure corresponding to the supercritical point or more, and each fluid is transferred to the post step.

According to the present invention, there is provided the method for manufacturing the secondary battery in which for the slurry, a plurality of slurries selected from different types of particles or fibers for an all-solid-state battery positive electrode are prepared, each slurry is pumped independently by a pump, and each slurry is merged with the pressurized carbon dioxide gas or liquefied carbon dioxide or supercritical fluid of carbon dioxide gas to form the merged fluid, each merged fluid is mixed to form the supercritical fluid, and the supercritical fluid is laminated or alternately laminated on the object with a respective coating device for supercritical fluid, and is laminated so that at least one coating layer of the mixed supercritical fluid is formed into a plurality of layers.

According to the present invention, there is provided the method for manufacturing the secondary battery, in which the particles or fibers of the all-solid-state battery positive electrode slurry include positive electrode active material particles, solid electrolyte particles, and a conductive assistant.

According to the present invention, there is provided the method for manufacturing the secondary battery in which the slurry is a negative electrode slurry.

According to the present invention, there is provided the method for manufacturing the secondary battery in which in forming the electrode, a gradient coating is performed so as to increase density of active material particles in a direction closer to a current collector and decrease the density of the active material in a direction away from the current collector.

According to the present invention, there is provided the method for manufacturing the secondary battery in which in forming the electrode between the current collector and a solid electrolyte layer being the objects of the all-solid-state battery, and in changing ratio of the active material particles to the solid electrolyte particles, gradient formation, in which weight or mass per unit area or unit volume of the active material is increased in a direction closer to the current collector, and the weight or mass per unit area or unit volume of the active material is decreased in a direction closer to the solid electrolyte layer, is performed by forming a plurality of layers with a continuous gradient or a stepwise gradient.

According to the present invention, there is provided the method for manufacturing the secondary battery in which the coating is a spray method or a pulsed spray method.

According to the present invention, there is provided the method for manufacturing the secondary battery in which the electrode binder is polyvinylidene fluoride, and 70% or more of the volatile component excluding the carbon dioxide gas or supercritical fluid of carbon dioxide gas is normal methylpyrrolidone.

In the present invention, a secondary battery or an all-solid-state battery can be manufactured by mixing the slurry and the liquefied carbon dioxide or carbon dioxide gas SCF (carbon dioxide gas supercritical fluid) to form SCF (supercritical fluid), which is coated to the object, and if necessary, it is layered coated to the object. If the merged fluid of slurry and liquefied carbon dioxide contains a slurry binder or/and a thickener, even if the initial solid content is high (for example, 50% or more, preferably 80% or more), and the viscosity is high (for example, 3000 mPa·s or more, more preferably 8000 mPa·s or more), the viscosity can be reduced to 100 mPa·s or less and a suitable airless spray can be performed by forming SCF, so SCF is preferable.

When the binder content is 1.5% or more, or even 5% or more, for example 70% as an extreme example, even if the viscosity is high, it can be suitably sprayed with SCF. This phenomenon is a big difference from the spray in the case of fluids that are not SCF but merged only with carbon dioxide gas.

A film can be formed by layered coating the merged fluid of slurry and carbon dioxide gas, or the merged fluid of slurry and carbon dioxide gas SCF (carbon dioxide gas supercritical fluid), or SCF thereof on a porous substrate such as a rotary screen in the form of a thin film by spraying to form a dry particle layer, which is guided and coated on an object placed in a vacuum chamber, further coating at a high density, or softening at least a part of the particles (aerosol deposition (AD) method).

In particular, in the AD method, since the film is not only formed by melting or softening, but in some cases, solid electrolyte particles may only be strongly pressed against each other, in particular, it is preferable that the solid electrolyte particles are easily crushed and deformed.

In particular, it is preferable that at least the positive electrode active material particles and the solid electrolyte particles have a broad particle size distribution, because fine particles can be densely filled in the gaps between large particles, and a dense and high-density particle laminate can be formed. However, in any case, a broad particle size distribution with coarse particle sizes of D90 or more, and if necessary D70 or more, is not preferred. In other words, a broad particle size distribution is acceptable for the small particle size, but an active material with a particle size distribution that does not have particles of D70 or D90 or more is preferable.

This is because the maximum particle size (Dmax) is generally allowed to be about 5 to 10 times the D50.

The active material does not need to have a single average particle size (D50), and it is better to prepare an active material with a sharp particle size distribution having a plurality of, for example, 1 to 10 different average particle sizes. Especially particles with an average particle size distribution of large particle size may be formed into a particle group having a sharp particle size distribution and select from among them. Although the particle size of D50 is not limited, for example, the minimum size of D50 is 300 nm and the maximum size of D50 is 5 μm, and each may be made into a separate slurry, or a plurality of slurries of multiple (for example, 3) selected particle groups may be formed. Furthermore, the 2 to 10 types of particle groups may be combined into one slurry and coated to the object. This method for preparing and coating the slurry can be applied to a variety of applications for multiple purposes, not limited to secondary batteries or SCF.

For the coating of the slurry or the like according to the present invention, if there is no binder or the ratio to the total solid content of the slurry is small (for example, 1% or less), it is not necessary to particularly form SCF if atomization is possible with the ejection force of the amount compressed by the liquid pressure of carbon dioxide gas. If the binder is a resin that easily entrains bubbles and the entrainment of bubbles or microbubbles in the resin layer is considered as a problem, it is better to make the merged fluid into SCF, for example, SCF that enables the atomization of spray particles by setting the viscosity to 25 mPa·s or less.

For SCF (supercritical fluid), there is no problem as long as the device can control the liquid pressure above the supercritical point of 7.38 MPa, for example, about 7.5 to 8 MPa or above, and the liquid temperature above the supercritical point of 31.1° C. or above, for example, 35° C. or above.

However, for example, if the spray is performed under the condition that the ratio of binder is high (e.g. 5% or even 10% or more) and the pressure or liquid temperature is below the supercritical point, the carbon dioxide gas contained in the binder solution will foam and impair the performance of coating film. If the liquefied carbon dioxide is added only to a binder solution with a solid content of 50% or more that does not contain solid particles to make SCF, and then the SCF is sprayed on the object with a liquid pressure of about 5 MPa for example, it will result in a binder layer full of bubbles containing the solvent of creamy resin or the like. The present inventor has been presenting this fact to the researchers who have no practical experience of SCF from the past and teaches the importance of the critical point of SCF.

For the fluid with microbubbles sucked by a pump with a relatively high liquid pressure, such as 3.5 MPa or more, or the gas fluid finely mixed in the pipe, it is difficult to visually check the presence or absence of bubbles from the outside using a pressure-resistant plate box made of transparent tempered glass or the like. A state in which the fluid containing microbubbles is sucked in, and the gas of the mixed fluid in which the gas is finely and uniformly mixed at the micro level is not dissolved, can be confirmed at a low pressure, but at a high pressure, fine bubbles are compressed by high pressure, and the bubbles are invisible in the flow path and appear as if they are dissolved. Accordingly, at a low pressure, it is possible to check whether bubbles contain microbubbles or not by pressure, but at a liquid pressure of 3.5 MPa or more, it is difficult to check microbubbles or the like in the flow path.

It is effective to prevent the sedimentation of solid particles by mixing the slurry with a relatively low viscosity (for example, 1000 mPa·s or less with a Brookfield viscometer) containing solid particles at a relatively low liquid pressure, for example, 0.03 to 2 MPa, with microbubbles in a slurry tank or the like, and then sucking it with a pump, or mixing gas downstream of the pump and circulating so that bubbles smaller than microbubbles are generated during coating and increasing the circulation flow velocity to, for example, 300 mm/sec or more. In this method, other than carbon dioxide gas, for example, air, nitrogen gas, or other inactive gas or the like can be used, and air spray, air-assisted airless spray, which is a type of two-fluid spray and in which spray is performed while ejecting compressed gas from the outside, and coating to the object from a coating head such as a fine particle ejection slit nozzle can be suitably used. As the air spray can eliminate bubbles by compressed gas collision to the extent that bubbles are not a problem, especially in the slurry of low viscosity during spray, for example, it is suitable for handling in a circulating circuit or the like of the merged fluid or mixture of bubbles and low-viscosity slurry in the upstream portion of the coating head, and needless to say, it can be used for forming secondary battery electrodes of the present invention, regardless of the type of slurry, application, or market. Furthermore, it can also be applied to slot nozzle system. In the slot nozzle system, the liquid pressure in the circulation circuit is set to 500 kPa (0.5 MPa) or less, further 200 kPa or less, and the slurry mixed with microbubbles is sucked by a pump, or the gas is dispersed in the slurry in the circulation circuit to lower the circulation pressure, thereby the slurry containing microbubbles can be suitably coated to the object while preventing the sedimentation of solid particles by increasing the flow velocity in the circulating circuit while reducing the compression rate of microbubbles. When the slurry is coated in the form of a relatively thin film, for example, 40 μm or less when dried, by heating the object to 30 to 150° C. shortly before coating, or during coating, or immediately after coating, microbubbles can be eliminated in a short time together with part of the high boiling point or medium boiling point solvent such as NMP contained in the slurry, therefore a thin film with little residual solvent can be formed until the next simple drying step. In the case that the object is a long R to R system, the object can be heated on the opposite surface of the coating side with a heating roll or a heating adsorption roll to increase productivity, and it can be laminated with the same slurry or different types of slurry by a plurality of slot nozzles. In addition, by using a suck-back valve as the automatic opening/closing valve of the slot nozzle, part of the slurry containing microbubbles in the cavity up to the tip portion of the slot nozzle downstream of the automatic opening/closing valve is sucked up by the sack back type automatic opening/closing valve, therefore even if the line speed is the speed of the current electrode forming line of lithium-ion secondary batteries (for example, 60 m/min.), intermittent coating of a desired coating pattern can be performed.

In order not to make a wrong setting for handling and coating the SCF, it is necessary to heat the fluid to, for example, 35° C. or higher and pressurize it to about 8 MPa or higher. On the other hand, the theory of SCF should be well understood when using the following systems, such as a slot nozzle (die) coating system that uses a circuit of a warm or hot airless system to reduce the liquid pressure as necessary to make it non-SCF, a slit nozzle coating system that makes slurry or the like into particles and ejects them from a long slit groove with the spray of SCF system, a dispenser coating system that also uses the SCF circuit, and an inkjet system that can withstand high pressure. In addition, a spray nozzle mechanism that makes droplets finer can be attached to the inkjet or dispenser.

It is even better to have a circuit under the above conditions in which the slurry or the like is transferred and circulated at high speed, for example, in a closed circuit which can maintain a supercritical state, so that particles of the slurry or the like do not precipitate. In addition, in the present invention, particularly spray fine particles containing fine particles that are nanoparticles of several nanometers to several hundreds of nanometers can be electrostatically charged and suitably adhered to the object by grounding. In the present invention, fine particle groups generated by spraying or the like can be transferred continuously or in a pulsed manner at high speed with the same or another compressed gas, converted into aerosol fluid, and jetted to be applied on a desired position in a desired pattern (for example, in an ultrafine pattern) regardless of wide width or narrow width. This method, especially the pulsed transfer, can be applied to a wide variety of fields such as the electronics field as well as this application. If the fine particles of the aerosol fluid have little adhesive force, they can be electrostatically charged or/and applied to the object together with the solvent vapor using the dew condensation phenomenon, so that an instantly dry and ultra-thin film can be formed by managing the heating of the object.

On the other hand, the present invention also includes a method of applying a melt blown method, which is a type of air spray, to the present invention to produce particles or fibers corresponding to wide and high-speed line-speed objects.

This method is suitable for a method performed at a pressure lower than that of SCF, in which microbubbles are mixed in the relatively low-viscosity slurry and circulated at a relatively high speed to prevent sedimentation of solid particles, and is suitable for slurry coating in other applications including the application of the present invention. The air assist coating method applied to spraying and slot nozzle coating refers to a method for giving directionality to spray particles and liquid films or the like from slot nozzles, and if necessary, pressing the coating film after coating with gas or accelerating atomization during spraying, and adhering or coating them to the object by the force of a compressed gas such as compressed air, argon or nitrogen gas that are inactive gases, if necessary, dry compressed air. The present invention can be suitably used for airless spray, slot nozzle system or the like. In the present invention, these methods of coating by forming particles are generically treated as spray.

As a preferred method of the present invention, active material particles for both electrodes, electrolyte particles, a binder, and short fibers are coated to the object with independent devices, or if necessary, for example, all materials for electrodes or some of them are selected, and a parent solvent for binder is added to make a slurry, which is mixed and merged with the carbon dioxide gas or carbon dioxide gas made into SCF until the foremost end of the coating device such as coating head, SCF is made as much as possible to be coated to the object. Furthermore, if necessary, the conductive assistant can be made into a dispersion with a solvent, or independently mixed with liquefied carbon dioxide or carbon dioxide gas SCF by an independent device, if necessary, mixed to form SCF, which is layered coated in the form of a thin film alternately with the electrode slurry that is also made into SCF by another independent coating device on the positive electrode current collector and the electrolyte layer object, which are objects. In this case, at least one of the solvents preferably has a medium to high boiling point such as NMP. In addition, according to the present invention, the slurry and the carbon dioxide gas or carbon dioxide gas made into SCF are merged, coated to the object, and if necessary, layered coated to manufacture a secondary battery or an all-solid-state battery. In the case that the merged fluid of slurry and carbon dioxide gas contains a binder of 1% or more of the solid content of the slurry, SCF is preferable.

A film can be formed by spray coating the merged fluid of slurry and carbon dioxide gas, or the merged fluid of slurry and carbon dioxide gas SCF, or SCF thereof on a substrate or a porous substrate to form particle layer, which is guided and coated on an object placed in a vacuum chamber, further is coated at a high density, or at least part of the particles are softened (aerosol deposition (AD) method). In the AD method, regardless of whether it is an oxide or a sulfide, it is preferable that the solid electrolyte particles are made of a material that is easily deformed and easily broken, and it is preferable that at least the active material particles of the positive electrode in particular have a broad particle size distribution and the solid electrolyte particles are fine powders (for example, an average particle size distribution of 1 μm or less), because small particles can be densely filled in the gaps between large particles, and a dense and high-density laminate can be formed. The active material does not need to have a single average particle size (D50), and may be particles having a plurality of, for example, 2 to 6, or even 2 to 10 different average particle size distributions. Each may be made into a separate slurry, or a plurality of slurries of multiple selected particle groups may be formed, or further all types of particles may be made into one slurry.

For the coating of the slurry or the like according to the present invention, if there is no binder or the ratio to the total solid content of the slurry is less than 1%, it is not necessary to particularly form supercritical fluid (SCF), but if the binder is a resin that easily entrains bubbles and the entrainment of microbubbles or nanometer bubbles in the resin layer is considered as a problem, it is better to form supercritical fluid (SCF).

The present invention enables a simple SCF system configuration, and the slurry and, for example, the carbon dioxide gas or SCF of carbon dioxide gas can be finely mixing while merging by an in-line mixer, or further finely mixed by another in-line mixer or the like after the merging of the slurry to form SCF until it reaches the coating head of the coating device and to be coated on the object. In addition, at the upstream of the coating device or coating head, the respective fluids can be mixed while being finely dispersed by a mixer including an inline mixer. The in-line mixer may be modified from, for example, a device for mixing gas and liquid sold by Hokuto Corporation, and the mixed fluid may be uniformly dispersed and mixed by arranging a filter screen or the like having openings of 50 μm or less with multilayer openings shifted. If the slurry, and if necessary, the liquefied carbon dioxide is pressurized to a temperature higher than the supercritical point (for example, 35° C. or higher) and a liquid pressure higher than the supercritical point, it takes a short time to reach the SCF. On the other hand, the viscosity of the slurry decreases by heating, and if the mass of liquefied carbon dioxide is increased relative to the solid content and solvent or the like, for example, if it is about 25 to 45% of the total solid content mass to make SCF, the viscosity of SCF will be 100 mPa·s or less, and further 50 mPa·s or less, so the spray suitability will be improved, but on the other hand, since the viscosity is low, it is important to circulate at a flow velocity that does not cause precipitation of the particles. As for the slurry with a high specific gravity and an average particle size of 5 μm or more, the flow velocity in pipes and hoses should be increased. For example, even if it is a dispersion in which the average particle size of the conductive assistant and the negative electrode active material is about several tens of nanometers, the dispersibility will be improved if handled in the same way. In the present invention, the slurry and the dispersion are collectively treated as slurry.

As a detailed supplementary explanation of the above, at the upstream of the automatic opening/closing valve attached to the coating head (spray head) or the like of the coating device, or just before the automatic opening/closing valve, or in the head, or at the spray nozzle portion, single or multiple slurries and SCF of carbon dioxide gas are merged, and mixed by a fine mixing device including an in-line mixer to keep the liquid pressure and liquid temperature above the SCF conditions and enable the coating to the object by spraying or the like. Furthermore, by the method of the present invention, the spitting phenomenon that the SCF in the cavity portion between the automatic opening/closing valve and the spray nozzle cannot maintain the SCF condition, and the carbon dioxide gas expands, especially the binder foams and pushes out the residue when the airless spray is finished, can be solved. The compressed gas can be blown, for example spot-wise, against the nozzle tip from a desired angle so that the spitting will not scatter to affect the object. This method is effective because if spitting occurs and adheres to the object especially when the spraying is performed in a pulsed manner, it becomes a fatal defect. The compressed gas to be blown may be carbon dioxide gas or nitrogen gas. Furthermore, compressed air may also be used. Blowing may be continuous or may take a desired short time before and after opening or closing the automatic opening/closing valve (spray head).

Needless to say, when it is sprayed after making it a supercritical fluid (SCF), the viscosity is low, so it can be sprayed with an airless spray nozzle having a low flow rate, for example, a flow rate of 228 ml/min. @ 3.5 MPa H20, with a pattern width of 10″ @ 10″. The above nozzle promotes atomization and also enables dry spray coating. In order to improve the coating rate regardless of the presence or absence of a binder, it is preferable to select a solvent which has a medium to high boiling point of 150° C. or higher and is easily electrostatically charged, and to add the solvent in a minute amount to moderate amount. In particular, MAK (methyl n-amylketone) is suitable for supercritical fluid (SCF).

Alternatively, since the dispersion spray of minute amount can be performed simply by dispersing the conductive assistant in liquefied carbon dioxide, it is important to form a state in which it can be well mixed with the active material by separately alternately laminating them in this method as well.

The positive electrode active material may be a ternary system of NMC. In addition, a composite enveloping silicon particles or silicon oxide, which are other active materials, by the single substance or three-dimensional structure of porous carbon, graphene, carbon nanotubes, carbon nanofibers, etc., which have a larger surface area than the usual negative electrode active material, is preferable. On the other hand, carbon nanofibers, single-walled carbon nanotubes or the like, which are often used to improve the performance of conductive assistants, tend to aggregate. As aggregation becomes remarkable, it is important to make a dispersion with good dispersibility by using them and a solvent or the like. In particular, short fibers of carbon nanofibers and single-walled carbon nanotubes or the like, or nano-sized carbon fine particles, which are conductive assistants, can be made into a slurry with a binder solution or the like, but instead, the dispersion can also be merged and mixed with liquefied carbon dioxide or carbon dioxide gas SCF (carbon dioxide gas supercritical fluid), and if necessary, it can be made into SCF, which is independently handled and dispersedly coated to a desired portion of the active material particles or the like or a desired position of the electrode layer.

In the present invention, carbon nanofibers or single-walled carbon tubes can be dispersed in liquefied carbon dioxide instead of a low boiling point solvent or a dispersion medium, and can be sprayed by heating the vicinity of the ejection port of the coating device as a dispersion. It may be sprayed by making a supercritical state.

In the present invention, a binder, a parent solvent of the binder, and those selected from an active material, solid electrolyte particles, or a conductive assistant, can be made into a slurry, mixed with carbon dioxide gas, and used as a supercritical fluid (SCF). Generally, when the slurry has a low solid content, for example, 40% or less, the viscosity tends to be low and it tends to precipitate during transferring, so that the solid content is as high as possible as long as it is fluid, for example, 50% or more, preferably 80% or more, and the viscosity is also preferably 3000 mPa·s or more, more preferably 8000 mPa·s or more.

Even if the slurry has a high solid content and does not flow over time, if it can be flowed by stirring, it can be automated by adopting a bulk feeder or the like that can pump up while pressurizing the slurry surface with a platen.

In the present invention, the active material and the solid electrolyte particles should be selected from those that do not lead to deterioration or performance degradation due to carbon dioxide gas or carbon dioxide gas SCF (carbon dioxide gas supercritical fluid). In the present invention, the type of sulfide-based or oxide-based solid electrolyte particles is not limited. In addition, the type of active material particles for positive electrode or negative electrode is not limited.

In addition, when there is a possibility of performance degradation or the like due to carbon dioxide gas or the like, the surface of the active material particles or the solid electrolyte particles may be barrier-coated or encapsulated at the nanometer level.

For example, when the electrolyte is sulfide-based, for example, lithium phosphorus sulfur (LPS), the positive electrode active material may be lithium sulfide (Li₂S) particles or a mixture of sulfur, especially octasulfur (S₈) particles, and a conductive assistant, and the negative electrode active material may be particles of graphite and silicon. The negative electrode may be a metallic lithium plate or a lithium alloy plate. In addition, when the electrolyte is an oxide-based lithium lanthanum zirconia (LLZ), the positive electrode active material may be octasulfur, and a conductive assistant such as carbon nanofibers and single-walled carbon nanotubes may be used to improve conductivity. The negative electrode active material may be a single substance such as graphene, porous carbon, carbon nanotubes, carbon nanofibers, or a composite or mixture of silicon or SiOx particles and a structure formed by selecting from graphene, porous carbon, carbon nanotubes, carbon nanofibers, or the like. In addition, when the positive electrode active material is lithium sulfide, the lithium conductive assistant may be a mixture of lithium iodide. Lithium iodide may be made into a solution with a parent solvent, and the solution can be further mixed with liquefied carbon dioxide to form SCF, or carbon dioxide gas can be made into SCF state and sent downstream together with the solution.

As a detailed supplement, at the upstream of the automatic opening/closing valve (spray head, etc.) of the coating device, or just before the automatic opening/closing valve, or in the head, or at the slot nozzle portion, single or multiple slurries and SCF of liquefied carbon dioxide are be merged, mixed with a fine mixing device using an inline mixer including a collision dispersion device and a dynamic mixer to keep the liquid pressure and liquid temperature above the SCF conditions and enable the coating to the object by spraying or the like.

In the method of the present invention, the spitting phenomenon that the SCF in the cavity portion between the automatic opening/closing valve (which is the automatic opening/closing portion of the spray gun) and the spray nozzle cannot maintain the SCF condition at the opening of the airless nozzle, especially the binder foams, and carbon dioxide gas expands to push out the residue when the airless spray is finished, is severe, so in the present invention, the compressed gas can be blown against the nozzle tip from a desired angle so that the spitting will not scatter to affect the object. It is effective because spitting becomes a fatal defect especially when the spraying is performed in a pulsed manner. The compressed gas to be blown may be carbon dioxide gas or nitrogen gas, since the atomization is easy. Furthermore, compressed air may also be used. Blowing may be continuous or may take a desired short time before and after opening or closing the automatic opening/closing valve (spray gun). It is rational to use those obtained by making SCF into spray particles for the particle generation of the slit spray nozzle, which can spray particles over a wide width from a narrow and long groove.

Fine particles or the like generated by spraying onto a rotating object or the like can be transferred by a carrier gas or the like and ejected from the slit portion.

In addition, the two-fluid spray in general, including melt blown method that uses a compressed gas, and the upstream of a system that includes an air-assisted slot nozzle may be in an SCF state, but it is even better to adopt the low-pressure circulation circuit with the microbubbles mixed, in which the microbubbles can be uniformly dispersed and formed at the moment they come out of the nozzle.

In the method of coating by atomization according to the present invention, particularly in the two-fluid spray method, the coating amount per unit area can be reduced to a small amount, so the aggregates up to the coating device can be coated on the object while being subdivided by the spray head.

In the present invention, for example, the positive electrode slurry using NMP as the parent solvent for binder and the liquefied carbon dioxide or carbon dioxide gas SCF (carbon dioxide gas supercritical fluid) can be merged, and finely mixed with an in-line mixer or the like, and if necessary, made into SCF with a low viscosity (for example, 50 mPa·s or less), which is coated on the object using an airless spray nozzle or the like.

The characteristic of SCF is that it can instantly form a wet electrode layer or electrolyte layer with a solid content of 80% or more with almost no carbon dioxide gas, and it can be increased to 85% or more by increasing the solid content of the slurry. Furthermore, the solid content can also be increased to 95% or more by heating the object to a desired temperature of 30 to 150° C. during coating.

On the other hand, the SCF can be made to have a viscosity of 100 mPa·s or less, more preferably 50 mPa·s or less, and more preferably about 25 mPa·s, in order to facilitate atomization of the spray. The sprayability is greatly improved, but on the other hand, especially when using active material particles or solid electrolyte particles with a large particle size, they tend to precipitate in a low-viscosity fluid. Therefore, in the present invention, the flow path of the SCF is made as small as possible, for example, the average inner diameter of pipe and hose including the entire SCF flow path is preferably ⅜ inches or less, and more preferably ¼ inches or less. The flow velocity is 0.3 m/s or more, and if necessary, preferably 0.5 m/s or more, and may be 1.2 m/s or more, or 2.0 m/s or more. For finer mixing, by installing an in-line mixer such as a dynamic mixer, a collision dispersion device, or a static mixer upstream of the circulation circuit, especially the coating head, due to the synergistic effect with the above flow velocity, a good particle-dispersed fluid can be obtained even if the viscosity is low. In addition, when the wetted portion of the mixer or dispersion device and the flow path where the particles collide are made of ceramics or metal, ceramic treatment is preferable, and the ceramics may be the material of the ball mill or bead mill for the particles, and can be selected from zirconia, alumina, chromium oxide, silicon carbide or the like. A plurality of ceramic-treated obstacles and filter meshes can be installed in the flow path.

The solid content of the undiluted solution of the positive electrode slurry is preferably 50% or more, more preferably 70% or more, and even 80% or more, also from the point of view of reducing the content of high boiling point solvent such as NMP and shortening the drying time. Viscosity is 2000 mPa·s or more, and 8000 mPa·s or more is acceptable if there is fluidity in a tank or the like.

To form SCF, the slurry can be heated in a circulation device (slurry handling device) or a coating device or even a coating head.

Needless to say, if SCF is desired, the inside of the circuit should be pressurized to a pressure higher than the supercritical point. For example, it can be achieved by using a commercially available heater that has passed the pressure-resistant explosion-proof labor inspection standards in the circulation device to heat the slurry, pressurizing it with a pump or the like, and connecting them with pipe (including pressure-resistant hose), and circulating the slurry to keep the liquid pressure at about 7.5 MPa or higher. In addition, in the present invention, when the particles tend to settle due to relatively low viscosity of 2000 mPa·s or less, or even 1000 mPa·s or less, the flow velocity can be increased and sedimentation can be prevented by mixing carbon dioxide gas or other gas such as air or nitrogen gas to generate fine bubbles in the circuit and circulating the slurry in the circulating device. In addition, NMP can be added to further reduce the viscosity and improve the spray suitability for spraying. Even in the case of a high-viscosity slurry with no or little binder, the cohesive force can be reduced by the power of the bubbles, so it is suitable for coating with a slot nozzle or two-fluid spray. On the other hand, when the object is heated, the medium to high boiling point solvent can be volatilized instantaneously due to the azeotropic phenomenon with the instantaneous evaporation of the liquefied carbon dioxide, so an ideal thick positive electrode layer or negative electrode layer can be formed with a desired film thickness per layer and lamination. The thickness of the positive electrode layer can be selected in a wide range from units of micrometers to units of millimeters.

In the present invention, the coating on the object can be performed in a state that the method of WO2013108669 invented by the present inventor is used to accurately manage the coating weight per unit area by coating on a coating weight measuring object for measurement before coating on the object. In addition, as a method that can apply the present invention in a wide range, especially when the object moves continuously in R to R or the like, the traversing coating head can overrun the object to enable the coating on the object for measurement each time or periodically for measurement, but the quality management can be performed by arranging a plurality of spray guns in parallel, using one of them exclusively for measurement to continuously perform measurement during operation, and checking changes in the fluid. As described above, the method can be suitably applied to the application of a continuous production line in which coating is continued other than the present invention, such as an R to R method. In addition, the density and flow rate of each SCF can be automatically measured using a commercially available measuring instrument, and can be controlled and managed so that the coating amount falls within the set value range. The consistency can be confirmed from the data obtained by the coating weight measuring device and the values obtained by measuring the flow rate and density from the inside of the pipe or the like and the outside of the flow path, and it can also be converted into data to automatically perform and control the supply of slurry and liquefied carbon dioxide to the SCF circuit. For this purpose, when the slurry, the liquefied carbon dioxide or carbon dioxide gas SCF (carbon dioxide gas supercritical fluid) are injected into the coating device or the circulation circuit of the coating device, it may be continuous, but if it is performed in a pulsed manner with cycles of 0.01 milliseconds to millisecond units and injection time of milliseconds, for example, 0.1 to 10 milliseconds, the ratio of solid content of the slurry to the liquefied carbon dioxide or carbon dioxide gas SCF (carbon dioxide gas supercritical fluid) can be easily controlled with high accuracy, so it is possible to improve the accuracy of the coating amount. Accordingly, the automatic opening/closing valve that injects fluid into the SCF circuit should have a pressure resistance of 7.5 MPa or more and respond within 10 milliseconds. Furthermore, a check valve for preventing backflow of SCF can be provided upstream or downstream of the automatic opening/closing valve. The downstream pressure of the automatic opening/closing valve is set a little lower than the SCF circulation pressure, and the moment the pressure drops during spraying, the sprayed amount is automatically fed in or sucked in by a pump, and circulated while maintaining a constant pressure to achieve stable automation. For this purpose, the pump is preferably an air-driven plunger pump with little pulsation, particularly a multiple-plunger pump with 2 to 6 series. In addition, by automatically measuring the coating amount, it is possible to instantly manage the coating weight of each material up to fine parts of the electrode, and to form electrodes or the like of the highest quality.

### Effects of Invention

As described above, according to the present invention, a secondary battery with high performance can be manufactured.

### BRIEF DESCRIPTION OF DRAWINGS

FIG. 1 is a schematic cross-sectional view of an embodiment of the present invention, in which the slurry is pressurized, transferred downstream, and merged with the liquefied carbon dioxide similarly transferred downstream in a coating device.

FIG. 2 is a schematic cross-sectional view of an embodiment of the present invention, in which the slurry is pressurized and circulated, and if necessary, the temperature and liquid pressure are set to above the supercritical point of the supercritical fluid of carbon dioxide gas, and the slurry is transferred to a downstream coating device, and the liquefied carbon dioxide is pressurized and circulated, heated if necessary, the carbon dioxide gas SCF (carbon dioxide gas supercritical fluid) is transferred to the coating device, merged and mixed with the slurry in the coating device.

FIG. 3 is a schematic cross-sectional view of an embodiment of the present invention, in which the slurry is pressurized by a pump and transferred upstream of the pump in the SCF circuit, and the liquefied carbon dioxide is also pressurized and adjusted by the pump and transferred upstream of the pump in the SCF circuit, and they are circulated in the SCF circuit while being heated by a heater downstream of the pump.

FIG. 4 is a schematic cross-sectional view of an embodiment of the present invention, in which the slurry is pressurized by a pump, heated and circulated, the heated and pressurized slurry is transferred upstream of the pump in the SCF circuit, and the liquefied carbon dioxide is also pressurized and circulated by a pump, and the heated liquefied carbon dioxide is transferred upstream of the pump in the SCF circuit, and a coating head is installed in the SCF circuit.

### DESCRIPTION OF EMBODIMENTS

In the following, preferred embodiments of the present invention will be described with reference to the drawings. The following embodiments are given only for the illustrative purpose to facilitate the understanding of the invention, and not intended to exclude feasible additions, replacements, modifications made thereto by persons skilled in the art without departing from the technical scope of the present invention.

The drawings schematically show preferred embodiments of the present invention.

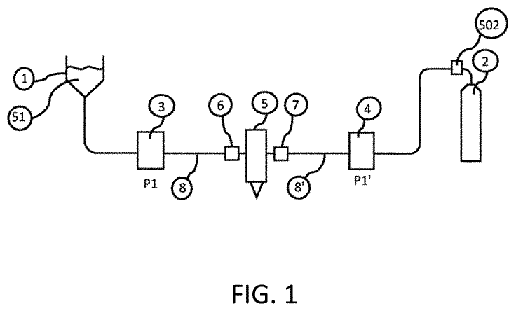

In FIG. 1, the slurry 51 in the tank 1 is pressurized by the pump 3, and transferred to the coating device 5 via the pipe (hose) 8, and if necessary, via the automatic opening/closing valve 6. On the other hand, the liquefied carbon dioxide 2 is pressurized by the pump 4 if necessary and sent to the coating device 5 via the automatic opening/closing valve 7 if desired. The coating device 5 may be a mixer or a coating head having an automatic opening/closing valve function for coating. The merged and finely mixed fluid can be made into SCF by setting the liquid pressure of the coating head to a desired liquid pressure abo ve the supercritical point of carbon dioxide gas and by setting the temperature to a desired temperature above the supercritical point if necessary, and it can be sprayed and atomized under suitable spray conditions of low viscosity, for example, 50 mPa·s or less, by using, for example, an airless spray nozzle at the tip of the coating head.

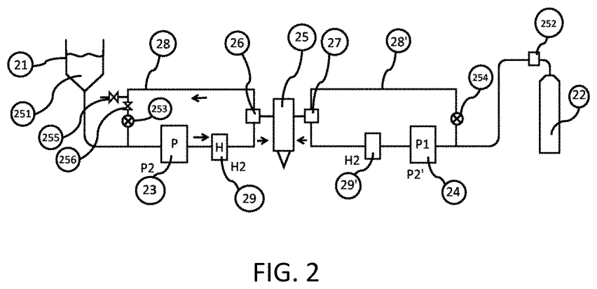

In FIG. 2, the slurry in the tank 21 is sucked by the pump 23, pressurized to an arbitrary pressure above the supercritical point of carbon dioxide gas, and sent to the commercially available pressure-resistant explosion-proof heater 29 to be heated. The heated slurry passes through the upper part of the automatic opening/closing valve 26, the flow rate is adjusted by the circulation valve 253 via the pipe (pressure-resistant hose) 28, and the slurry is sucked again by the pump 23 to form a circulation circuit. The pump 23 can be selected from a gear pump, a screw pump, a centrifugal pump, a multiple-plunger pump, etc., and the power may be an electric motor such as a servo motor. In order to keep the pressure constant, an air pressure-driven multiple-plunger pump of a balance feed type (instantaneous follow-up when the pressure collapses) with little pulsation can instantly suck the flow amount transferred from the automatic opening/closing valve 26 to the downstream coating device 25 by the pump 23, thereby it exerts its effect with little pulsation. On the other hand, the liquefied carbon dioxide 22 passes through the pressure regulating valve 252, and is directly or via the automatic opening/closing valve 27, or pressurized by the pump 24, heated by the heater 29′, and passes through the upper part of the automatic opening/closing valve 27, and sucked again by the pump 24 via the pipe (hose) 28 and via the circulation valve 254 to form a circulation circuit, and the pump continues to operate. The type of the pump 24 is preferably a bellows pump, and the flow amount transferred downstream from the automatic opening/closing valve flows into the pump 24. In both circuits, it is even better if the pressure and temperature are set at an arbitrary value above the supercritical point.

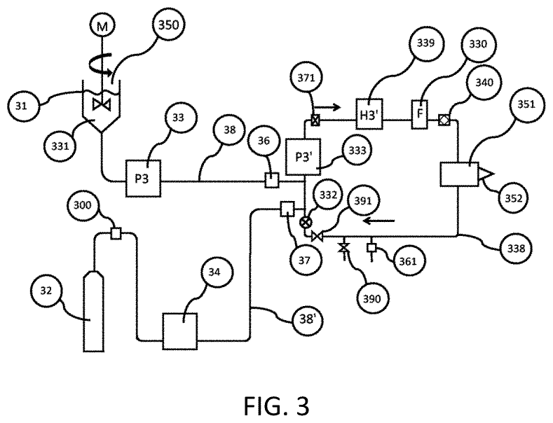

In FIG. 3, the slurry 331 in the tank 31 is sucked by the pump 33, pressurized, and sucked by the pump 333 of the supercritical fluid circuit via the pipe 38 and further via the automatic opening/closing valve 36. In addition, the liquefied carbon dioxide is pressurized to a desired pressure by the pump 34 and also sucked by the pump 333 via the automatic opening/closing valve 37. The pressurized slurry 331 and the liquefied carbon dioxide 32 may be merged and mixed by an in-line mixer or the like, or may be sucked by the pump 333. The in-line mixer 371 is installed downstream of the pump 333, and the slurry and the carbon dioxide gas are finely mixed, and sucked by the pump 333 via the explosion-proof heater 339, the filter 330, the density or flow rate sensor 340, and via the coating head 351, the pipe 338, and further via the circulation valve 332, to form a circulation circuit, and SCF can be formed by setting the liquid pressure and temperature to desired values above the supercritical point. When SCF is formed, the viscosity can be lowered, so it can be coated on the object while being atomized by the airless spray nozzle 352 or the like downstream of the coating head. Needless to say, by relatively moving the coating head and the object, it is possible to be coated in multiple layers in the form of a thin film. In addition, the circulation circuit can be provided with the automatic drain valve 361, the manual drain valve 390, the stop valve 391, the circulation valve 332, the density sensor 340 or the like. In addition, the slurry 331 in the tank 31 can be automatically stirred by the stirring device 350 if necessary.

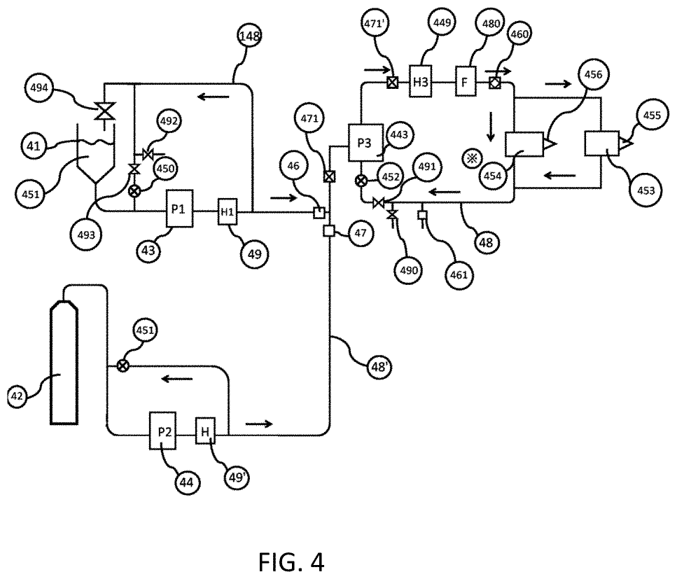

In FIG. 4, the slurry 451 and the liquefied carbon dioxide 42 are the same in terms of supply to the coating device, so description thereof will be omitted. The respective automatic opening/closing valves 46 and 47 are mounted on the in-line mixer 471, and can be modified for SCF from, for example, the TD type of Hokuto Corporation, which is capable of simultaneous merging and mixing. In addition, a plate or a filter with countless porous bodies, a laminate thereof, a static mixer, a dynamic mixer, etc., which is a type of in-line mixer, can be applied after the merging. The merged fluid is sucked by the pump 443 and pressurized and pumped, and if necessary, finely mixed by the in-line mixer 471′, heated by the heater 449, the agglomerates and foreign substances are filtered by a filter, the mixing is supported if necessary, and the mixing condition of the fluid is managed by the density sensor 460 if necessary, the circulation flow rate is adjusted by the circulation valve 452 via the coating heads 455 and 456 connected in parallel circuit, and via the pipe 48, and the fluid is sucked again and pumped by the pump 443 to form a circulation circuit. By setting the pressure and temperature of the fluid to desired values above the supercritical point of carbon dioxide gas, the finely mixed fluid of the merged fluid become SCF, which is sprayed on the object by the airless nozzles 455 and 456 attached to the tips of coating heads 453 and 454. The coating head may be a simple airless spray gun improved for SCF and may be manual or automatic, and in any number. In order to pursue an accurate coating weight by moving the coating heads 453 and 454 and the object relative to each other, the coating head 455 can be traversed to accurately spray coat the object. A plurality of coating heads, for example, 10, may be used regardless of traverse, stationary spray, etc. At least one of a plurality of coating heads can be used exclusively for coating weight measurement and can be used as data for quality management and automatic control of the coating amount over time.

In the present invention, in order to improve productivity, for example, a slot nozzle with a coating width of 50 to 1500 mm can be used. Fine particles can be ejected from a slit nozzle consisting of a narrow, long groove with a wide width equivalent to the slot nozzle, and can be coated to the object corresponding to the high-speed line speed. In addition, for each layer of one type of slurry coated, 1 to 200 heads such as spraying heads can be arranged in one row, substantially one row or a plurality of rows orthogonal to the moving direction of the object to form a head group to enable the spraying or spraying with impact in a pulsed manner. If necessary, the head group can be reciprocated (swing) by, for example, 15 mm in the head arrangement direction to sufficiently wrap and coat a pattern of, for example, 15 mm. Heads for a required type of slurry and heads for a desired number of times of lamination can be arranged to meet the required speed.

In addition, a plurality of rotary screens or the like may be installed for coating in the moving direction by applying the method of JPH6-86956 also invented by the present inventor. By filling the sprayed amount to innumerous holes that penetrate through a wide range (for example, holes with a diameter of about 150 to 300 μm) in cylindrical screens or seamless belts or pipes made of stainless steel or the like that are the same as or wider than the coating width of the object, and blowing out with liquefied gas or compressed gas at the place facing the object, it can be made into fine particles and adhere to the object uniformly over the entire surface. It is cheap to use a commercially available sheet screen for screen printing or a screen for rotary screen.

In the above method, it is better to set the distance between the position where the atomization and blow-out is performed and the object to be about 1 to 60 mm because the impact effect is improved. It is even better to arrange them in multiple rows in the moving direction of the object and then to perform a thin film layered coating. Through-holes of screen and cylinder can be formed, for example, in a pattern corresponding to a cell. As a matter needless to say, it can also be continuously coated on the object without interrupting the coating. In addition, the above method also serves as a positive displacement supply method, and it can also follow the line by changing the rotation speed, so that an expensive positive displacement pump or controller or the like is not required, and the device design and manufacture can be carried out on the extension line of R to R of the roll coater and the rotary screen printing method. And it is a positive displacement type different from the above-mentioned method, so it is also possible to simply modify and use a part of the conventional lithium battery electrode forming lines.

In the present invention, a method of making the slurry into particles and transferring them by pressure difference may be used, inkjet and dispenser may be used for atomization. As for inkjet and dispenser, it can be coated in the form of a thin film by further micronizing the particles with a compressed gas or the like. In addition, it may be atomized by a rotary atomizer such as a disc or a bell used in the general coating field, and may be coated by transferring with carrier gas or the like by using the particle group. Other than that, in the case of low viscosity, atomization with a bubbler or ultrasonic wave, or a method of hitting a spraying flow against a rotating roll or belt, etc., at an extremely close distance for further micronization regardless of viscosity or the like can be used. The particle group atomized as described above may be transferred and adhered to the object by differential pressure of a carrier gas or the like. Adhesion of the particles to the object may be performed by being electrostatically charged or dew condensed with solvent vapor. The synergistic effect of the two is even better.

This method can be widely applied not only in the field of secondary batteries but also in coatings or the like in the fields of solar cells, semiconductors, electronics, biotechnology, pharmaceuticals or the like. The carrier gas can be pulsed and the uniform coating is also possible on uneven surfaces. By charging the fine particles as described above, the uniformity and coating efficiency can be further improved and a good effect can be exhibited.

Further, it is even better if the transferring is performed in a pulsed manner because the adhesion efficiency and impact are increased.

### INDUSTRIAL APPLICABILITY

The present invention can contribute to improving the productivity and performance of secondary batteries.

Even if NMP is used, the mainstream of which evaporates slowly and is the solvent for the slurry especially for forming positive electrodes of secondary batteries, it can be volatilized at a relatively low temperature in a short time according to the present invention, so it leads to resource saving, energy saving and space saving, and can greatly reduce cost and improve productivity. Since a positive electrode having a thick film thickness without defects such as cracks can be formed, which is difficult with conventional methods, a secondary battery with high performance can be manufactured. In addition, the slurry is made into fine particles mainly by a spray method or the like and instantaneously wet and adhere to the object with impact, so not only the electrode layer of the secondary electrode with high adhesion and low interfacial resistance, but also a laminate of electrolyte layer and electrode layer of an all-solid-state battery can also be manufactured with a thick film thickness and high quality from a desired thin film by spray coating simultaneously on the R to R object, such as the electrode layer and the solid electrolyte layer.

### DESCRIPTION OF THE REFERENCE NUMERAL

1, 21, 31, 41 tank
2, 22, 32, 42 liquefied carbon dioxide
51, 251, 331, 451 slurry
3, 4, 23, 24, 33, 34, 43, 44, 333, 441, 443 pump
5, 25 coating device
6, 7, 26, 27, 36, 37, 46, 47 automatic opening/closing valve
8, 8′, 28, 28′, 38, 38′, 48, 48′, 148, 338 pipe
29, 29′, 49, 49′, 449, 339 heater
252, 300, 502 carbon dioxide gas pressure regulating valve
253, 254, 332, 450, 452 circulation valve
255, 390, 490, 492 manual drain valve
256, 391, 491, 493 stop valve
361, 461 automatic drain valve
351, 453, 454 coating head
455, 456 spray nozzle
471, 471′ in-line mixer

1. A method for manufacturing a secondary battery by coating an electrode slurry on an object for a secondary battery, comprising:
a pressurizing step of pressurizing and transferring the slurry to post step,
a transferring step of transferring pressurized carbon dioxide gas or liquefied carbon dioxide or supercritical fluid of carbon dioxide gas to the post step,
a mixing step of merging and mixing the slurry and the carbon dioxide gas or the liquefied carbon dioxide or the supercritical fluid of carbon dioxide gas to obtain a mixture, and
a coating step of coating the mixture on the object or layered coating thereof in form of a plurality of layers with a coating device.

2. The method according to claim 1, wherein the mixing step is a step of making a supercritical fluid.

3. The method according to claim 1, wherein merged fluid is mixed by an in-line mixer installed between before and after the merging.

4. The method according to claim 1, wherein at least one fluid of the slurry and the carbon dioxide gas is transferred to the post step via an automatic opening/closing valve.

5. The method according to claim 3, wherein liquid pressure and temperature of the merged fluid comprising the slurry and the carbon dioxide gas are set to supercritical point or more, the merged fluid is circulated by a circulation device for supercritical fluid to form the supercritical fluid, and the supercritical fluid is coated to the object.

6. The method according to claim 1, wherein the secondary battery is an all-solid-state battery.

7. The method according to claim 6, wherein the electrode slurry is a solid electrolyte slurry.

8. The method according to claim 1, wherein at least one fluid of the slurry and the pressurized carbon dioxide gas or liquefied carbon dioxide is circulated at a temperature and pressure corresponding to the supercritical point or more, and each fluid is transferred to the post step.

9. The method according to claim 3, wherein for the slurry, a plurality of slurries selected from different types of particles or fibers for an all-solid-state battery positive electrode are prepared, each slurry is pumped independently by a pump, and each slurry is merged with the pressurized carbon dioxide gas or liquefied carbon dioxide or supercritical fluid of carbon dioxide gas to form the merged fluid, each merged fluid is mixed to form the supercritical fluid, and the supercritical fluid is laminated or alternately laminated on the object with a respective coating device for supercritical fluid, and is laminated so that at least one coating layer of the mixed supercritical fluid is formed into a plurality of layers.

10. The method according to claim 9, wherein the particles or fibers of the all-solid-state battery positive electrode slurry comprise positive electrode active material particles, solid electrolyte particles, and a conductive assistant.

11. The method according to claim 1, wherein the slurry is a negative electrode slurry.

12. The method according to claim 1, wherein in forming the electrode, a gradient coating is performed so as to increase density of active material particles in a direction closer to a current collector and decrease the density of the active material in a direction away from the current collector.

13. The method according to claim 12, wherein in forming the electrode between the current collector and a solid electrolyte layer which are the objects of the all-solid-state battery, and in changing ratio of the active material particles to the solid electrolyte particles, gradient formation, wherein weight or mass per unit area or unit volume of the active material is increased in a direction closer to the current collector, and the weight or mass per unit area or unit volume of the active material is decreased in a direction closer to the solid electrolyte layer, is performed by forming a plurality of layers with a continuous gradient or a stepwise gradient.

14. The method according to claim 1, wherein the coating is a spraying method or a pulsed spraying method.

15. The method according to claim 1, wherein electrode binder is polyvinylidene fluoride, and 70% or more of volatile component excluding the carbon dioxide gas or supercritical fluid of carbon dioxide gas is normal methylpyrrolidone.
